(19) United States
(12) Patent Application Publication
(10) Pub. No.: US 2024/0289334 A1
(43) Pub. Date: Aug. 29, 2024

(54) STREAMING AGGREGATION QUERIES

(71) Applicant: Microsoft Technology Licensing, LLC, Redmond, WA (US)

(72) Inventors: Nathaniel Jesse MILLER, Seattle, WA (US); Youke SHEN, Sammamish, WA (US); Guang YANG, Bothell, WA (US); Venugopal LATCHUPATULA, Sammamish, WA (US); Gaurav KAPILA, Redmond, WA (US)

(73) Assignee: Microsoft Technology Licensing, LLC, Redmond, WA (US)

(21) Appl. No.: 18/176,286

(22) Filed: Feb. 28, 2023

(51) Int. Cl. G06F 16/2455; G06F 16/22; G06F 16/2453

(52) U.S. Cl. CPC G06F 16/24556; G06F 16/2255; G06F 16/24535; G06F 16/24537; G06F 16/24568

(57) ABSTRACT

An example computing device for streaming aggregation queries is provided. The computing device comprises a processor and memory storing instructions that cause the processor to receive a query from a caller, wherein the query comprises an aggregation operator, retrieve data comprising a plurality of data entries, determine first and second subsets of data entries from the plurality of data entries, wherein the first subset of data entries comprises data entries having disjointed keys and the second subset of data entries comprises data entries having intersecting keys, return the first subset of data entries to the caller, release the first subset of data entries from the memory, after releasing the first subset of data entries from the memory, aggregate the second subset of data entries using an aggregation operation corresponding to the aggregation operator, and return the aggregated second subset of data entries to the caller.

### BACKGROUND

A database refers to a collection of data organized as structured information. Typically stored and accessed electronically on a computer system, data within common types of databases is generally formatted as a series of tables containing rows and columns. Data formatted as such can then be accessed, modified, and managed through use of database management system software and accompanying database language, such as structured query language (SQL), for data querying and processing. Databases can be stored on various systems, including local storage and remote storage. Smaller databases are typically stored on a local file system while larger databases are typically stored on computer servers or cloud storage.

### SUMMARY

An example computing device for streaming aggregation queries is provided. The computing device comprises a processor and memory storing instructions that cause the processor to receive a query from a caller, wherein the query comprises an aggregation operator, retrieve data comprising a plurality of data entries, determine first and second subsets of data entries from the plurality of data entries, wherein the first subset of data entries comprises data entries having disjointed keys and the second subset of data entries comprises data entries having intersecting keys, return the first subset of data entries to the caller, release the first subset of data entries from the memory, after releasing the first subset of data entries from the memory, aggregate the second subset of data entries using an aggregation operation corresponding to the aggregation operator, and return the aggregated second subset of data entries to the caller.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system for streaming aggregation queries in a distributed database system.

FIG. 2 schematically illustrates a block diagram of an example database model.

FIGS. 3A-3F show a series of steps for an example two-phase aggregation flow.

FIG. 4 shows a flow diagram of an example method for streaming aggregation queries.

FIG. 5 shows a schematic view of an example computing environment in which the computer device of FIG. 1 may be enacted.

### DETAILED DESCRIPTION

A sailfish query engine operates on partitioned data distributed across nodes that hold the data. The data within a node can be further sub-divided into extents, which are logical units of data serialization. Such a database system enables distributed execution of certain operations. For example, an operator can be executed in parallel across extents, with partial results being returned to a node-level caller. The operator can run in parallel at the node-level, with partial results returned to a top-level caller. The top-level instance then merges the node-level results to provide the final operator results.

A sailfish query engine can be implemented in various ways. One such example includes the waterfall execution model. In such models, a guiding design principle is to accumulate less during execution. For example, execution of a streaming operator in a waterfall execution model is divided into chunks that are sequentially pulled into memory, evaluated, and then discarded. In a practical implementation, a call to move to the next batch of data disposes the previous state, if there exist any. Computations are then performed on the next chunk, and the results are stored in memory. Calls to get the data return a pointer to the current results stored in memory. This allows the query engine to operate on data sets whose sizes exceed that of memory.

While execution of streaming operators is relatively straightforward, several other operators present different considerations. One such type includes accumulating operators. In contrast to streaming operators, which operate on a single source chunk at a time, accumulating operators read in all source data before returning a single result. This violates the guiding principle to accumulate less that benefits other pipeline-based operators, such as the streaming operators described above. During execution of an accumulating operator, all source chunks are read in, in response to the first call to move to the next, or first, batch of data. As a result, the memory footprint of these operators can be equivalent to the size of their input.

As a more specific example, aggregation operators are a subset of accumulating operators that perform various reduction/combination functions. Example aggregation operators include max, min, make_list, percentile, average, count, and sum. During execution, the aggregation engine flow typically holds the entire result payload in memory. For high cardinality result sets, peak memory usage can be a major scaling bottleneck for practical implementations. For example, let N be the cardinality of the aggregation input, K be the cardinality of the aggregation output, and B be the branching factor of the parallel subquery. At each iteration in the aggregation flow, an input result block is evaluated and added to the in-memory aggregation engine that accumulates the output. Thus, the peak memory usage of a node is equal to the size of an input block and the accumulated output. In the case of low cardinality (i.e., K*B<N), the peak memory usage at the top-level node is usually less than that of the lower-level node operators. However, in the case of high cardinality (i.e., K≈N), the peak memory usage at the top-level node is roughly the sum of that of the immediate lower-level nodes. Such execution is difficult to scale and can cause memory-related crashes for high data volume queries.

Two main approaches, including hybrids thereof, are typically implemented in current distributed aggregation engines. One approach includes implementing an aggregate accumulator per group-by key. A group-by key refers to the key payload that is being grouped together in accordance with the aggregation function. In this approach, the source is streamed, and the output is accumulated by the group-by key. As described above, memory-related issues are likely to occur in high-cardinality cases for this approach. In the second approach, the group-by keys' values are accumulated in memory. Partial results are calculated according to the aggregation operator. The keys are sorted, and partial results are streamed to higher-level nodes where merge-sort can be performed. As such, the final top-level reduction can be streamed. This approach is memory prohibitive in the low-cardinality case and CPU intensive in the high-cardinality case.

In view of the observations above, aspects of database computing devices for streaming aggregation queries are provided. In comparison to existing approaches, such aspects for streaming aggregation queries can be implemented to provide solutions that are more efficient in peak aggregation resource usage—e.g., more memory efficient in both low—and high-cardinality scenarios without incurring substantial CPU-overhead from key sorting. In some implementations, the solution implemented is query-pattern independent—i.e., the solution is not dependent on specific columns projected in user query. The solution can also be implemented to be aggregate agnostic, enabling implementation for aggregate functions that are associative decomposable.

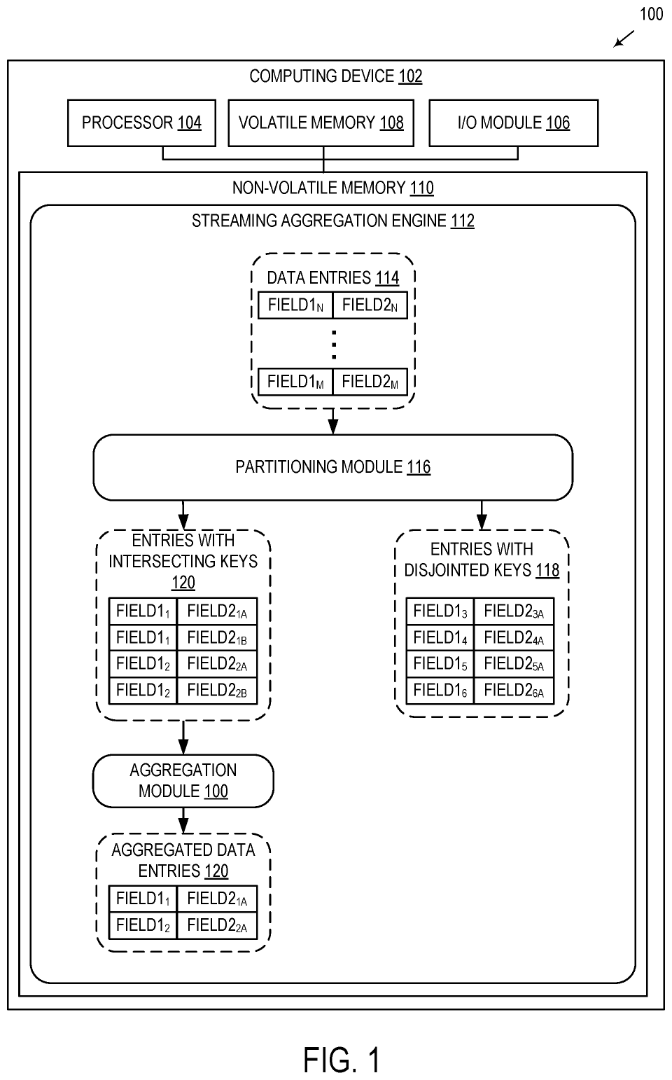

Referring now to FIG. 1, a schematic view of an example computing system 100 for streaming aggregation queries in a distributed database system is illustrated. The computing system 100 includes a computing device 102. The computing device includes a processor 104 (e.g., central processing units, or “CPUs”), an input/output (I/O) module 106, volatile memory 108, and non-volatile memory 110. The different components are operatively coupled to one another. The non-volatile memory 110 stores a streaming aggregation engine 112, which contains instructions for the various software modules described herein for execution by the processor 104.

In response to an aggregation query from a caller, the instructions stored in the streaming aggregation engine 112 are executed by the processor 104 to initialize the streaming aggregation process for the computing device 102. The computing device 102 can be implemented as a node in a distributed database system. The distributed database system can be implemented as a plurality of nodes arranged in a tree structure. The caller can be a higher-level node or, if computing device 102 is a top-level node, a user. In a distributed database system, nodes can be implemented to hold sets of data. Distributed execution of aggregation operations in such systems can be performed by running the aggregation operator in parallel across nodes, with partial results returned to higher-level nodes where they can be merged.

The streaming aggregation process begins with retrieving data entries 114. The data entries 114 can be retrieved from different sources depending on the implementation of computing device 102. In some implementations, the data entries 114 are retrieved from one or more lower-level nodes, relative to the computing device 102, in the distributed database system. The lower-level nodes can be implemented logically within the computing device 102 or as physically separate devices. In some implementations, the data entries 114 are retrieved locally from the storage of the computing device 102. For example, the computing device 102 can be a lowest-level node in the distributed database system, and the data entries 114 are stored locally. In another example, the data entries 114 are retrieved from local storage from lower-level nodes implemented logically within the computing device 102. The data entries 114 can be organized in various ways. In the example implementation, the data entries 114 are organized as tables containing rows and columns, with each data entry 114 being represented as a row in a table. Each data entry 114 includes various fields. In the depicted computing system 102, each data entry 114 includes example fields FIELD1 and FIELD2. Any other format can be implemented.

In an aggregation engine for a distributed database system, simply concatenating sub-results at a higher-level node can lead to incorrect final results if there are group-by key values that appear multiple times. As such, the aggregation operator is typically run at every node level to correctly compute the final results. However, this leads to high peak memory usage for high-cardinality cases. For example, the peak memory usage can be the size of all partial results received. For high-cardinality data sets, such memory usage is inefficient and can be a scaling bottleneck.

In view of these issues, the streaming aggregation framework provided herein can be implemented to reduce peak memory usage by streaming a portion of the data while performing aggregation on the remaining portion. To maintain correct results, the portions can be determined by partitioning the group-by key values into sets of disjointed and intersecting keys. A disjointed key is a key value that occurs once across sub-results. An intersecting key is a key value that occurs at least two times across sub-results. The disjointed set of keys can be streamed to a higher-level node while an aggregation computation can be performed on the set of intersecting keys. As the streamed results do not need to be accumulated in memory during the aggregation computation, peak memory usage can be reduced. For relatively higher-cardinality cases, a higher portion of the group-by keys is disjointed, and peak memory usage is reduced correspondingly.

Referring back to FIG. 1, the streaming aggregation engine 112 includes a partitioning module 116 for partitioning the data entries 114 into two sets, one with disjointed keys 118 and another with intersecting keys 120. Various techniques can be utilized to determine the data entry sets with disjointed 118 and intersecting 120 keys. For example, techniques for determining duplicate keys in a given set can be used to partition the data entries 114 into data entry sets with disjointed 118 and intersecting 120 keys, where the data entries containing duplicate keys make up the data entry set with intersecting keys 120 and the remaining data entries, which contain unique keys, make up the data entry set with intersecting keys 120. In the depicted example, FIELD1 is the group-by key. As a result, the data entry set with intersecting keys 120 includes data entries with intersecting FIELD1 values. The data entry set with disjointed keys 118 includes the remaining data entries, which contain disjointed FIELD1 values.

Various techniques can be implemented for determining intersecting group-by keys. For example, intersecting group-by keys can be determined by counting the occurrences of each group-by key value. An example technique includes the use of nested loops where each group-by key is compared to every other group-by key to determine multiple occurrences. Another technique includes the use of a sorting algorithm to sort the group-by keys. Intersecting group-by keys can be determined by scanning the sorted list to find repeating adjacent elements. As can readily be appreciated, different techniques can result in different time complexities. In some implementations, a technique with a linear time complexity O(n) is implemented to determine intersecting group-by keys. For example, a hashmap function can be utilized to determine intersecting group-by keys. Techniques of any other time complexity can also be utilized.

After the data entry sets with disjointed 118 and intersecting 120 keys are determined, the data entry set with disjointed keys 118 can be streamed to the caller, such as a higher-level node or a user. In some implementations, the data entry set with disjointed keys 118 is released from memory after it is streamed to the caller. For example, when computing device 102 is implemented as an intermediate or top-level node, the data entries can be retrieved and stored in memory during the query. After partial results are streamed, they can be released from memory. This can reduce peak memory usage when further data is accumulated for the aggregation operation.

The streaming aggregation engine 112 includes an aggregation module 122 for performing an aggregation operation on the data entry set with intersecting keys 120 to form an aggregated data entry set 120, where the aggregation operation corresponds to the aggregation query. Example aggregation operators include max, min, make_list, percentile, average, count, and sum. The aggregated data entry set 120 can then be streamed to the caller. After the aggregated data entry set 120 is streamed, it can be released from memory. The aggregated data entry set 120 and the data entry set with disjointed keys 118 form the final result with respect to the query from the caller.

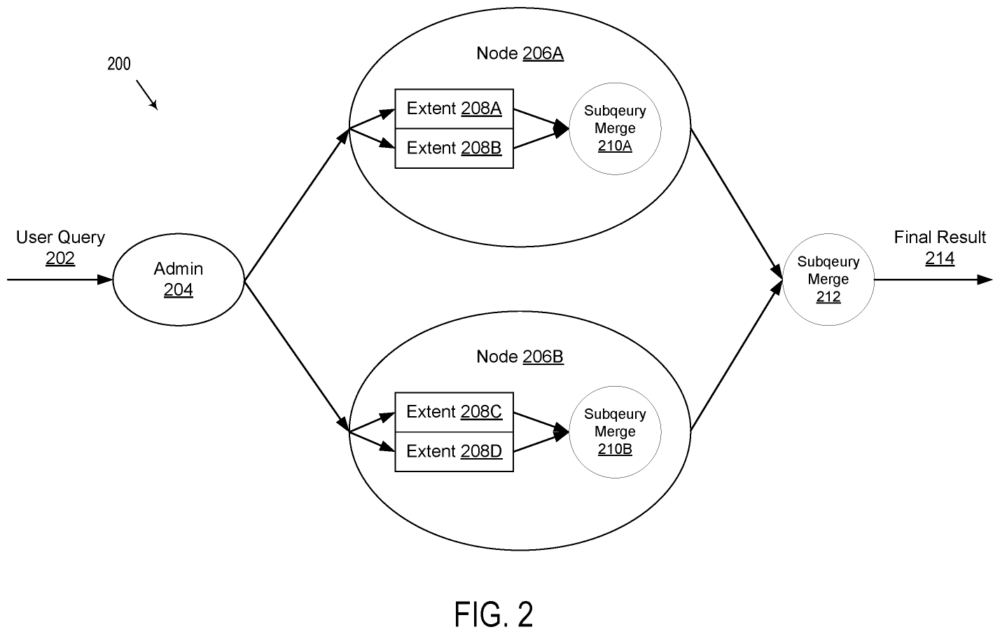

The computing device 102 of FIG. 1 can be implemented in a distributed database system in many different ways. For example, it can be implemented as a top-level node, intermediate-level node, or a bottom-level node. In some implementations, the computing device 102 is implemented as a node holding data that is sub-divided into extents, which are logical lower-level nodes. FIG. 2 schematically illustrates a block diagram of an example database model 200. In the depicted example, a user query 202 is provided to an administrator 204 that performs subquery calls to two nodes 206A, 206B. Data held by the first worker node 206A is divided into a first extent 208A and a second extent 208B. Data held by the second node 206B is divided into a third extent 208C and a fourth extent 208D. Extents 208A-208D are implemented as lower-level nodes within nodes 206A, 206B. During execution of an aggregation operation, the operator runs in parallel across extents, and partial results are returned to the node-level. As shown, subqueries are performed on the extents 208A-208D with partial results being merged 210A, 210B at the worker node-level. The operator runs in parallel at the worker node-level, and partial results are returned to a top-level instance. The single top-level instance merges 212 the node-level results to return a final result 214.

In addition to different database system structures, different variations of streaming aggregation engines can also be implemented. For example, a two-phase aggregation flow engine can be implemented. In such a process, lower-level nodes can stream the group-by keys (or hashes of the group-by keys) with null or dummy values in the remaining fields to a higher-level node. The higher-level node accumulates the streamed group-by keys in memory during a first pass to determine the occurrences of each group-by key value to determine disjointed and intersecting keys. This enables determination of disjointed and intersecting keys without accumulating additional data (such as data in the other fields) in memory. In a second pass, subqueries return the full rows of data, which are then partitioned based on the occurrence count. For example, a first subquery to a first sub-node returns a first set of data. Data with disjointed keys can be determined by the previously calculated occurrences and streamed to a caller. The process repeats with a second subquery to a second sub-node. The remaining entries can then be aggregated and streamed to the caller. As a result, aggregated data from the two sub-nodes are returned to the caller with peak memory usage being less than the size of the entire data sets from the two sub-nodes.

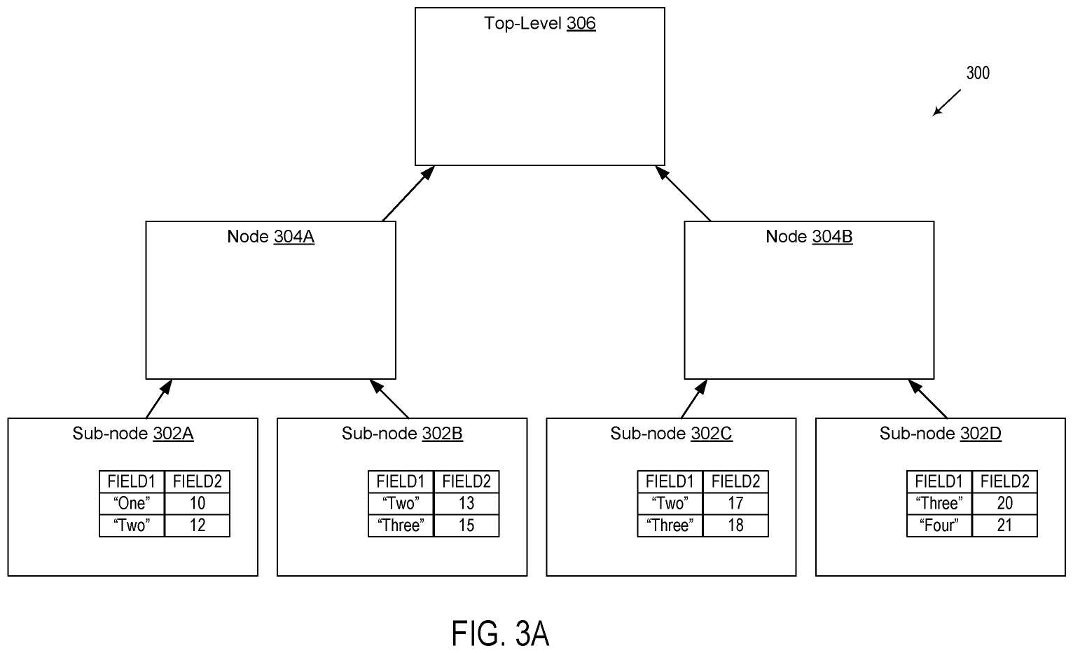

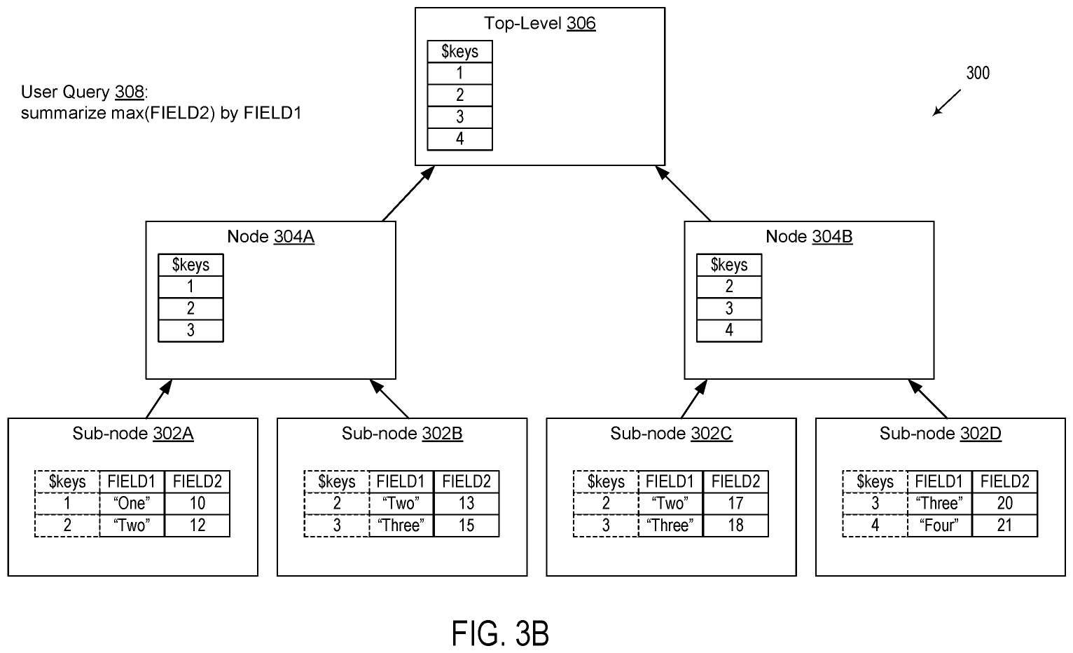

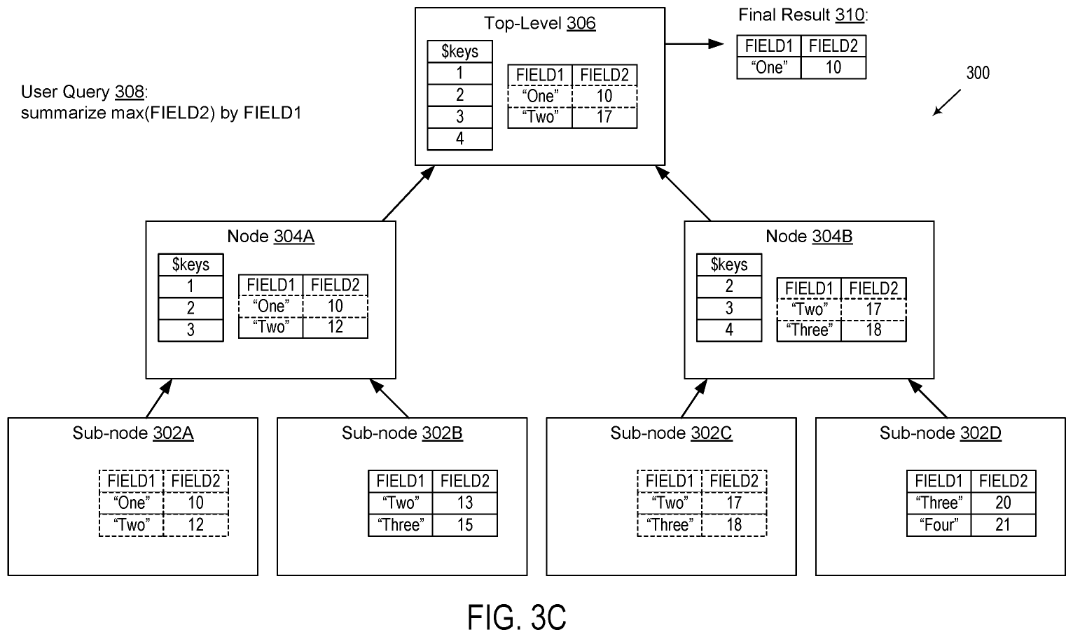

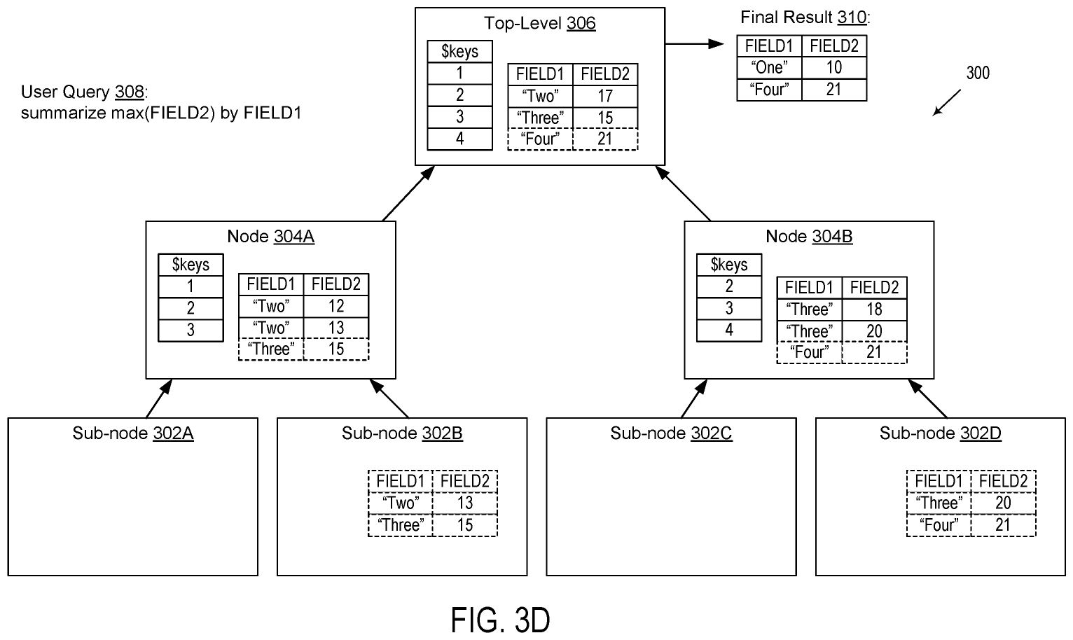

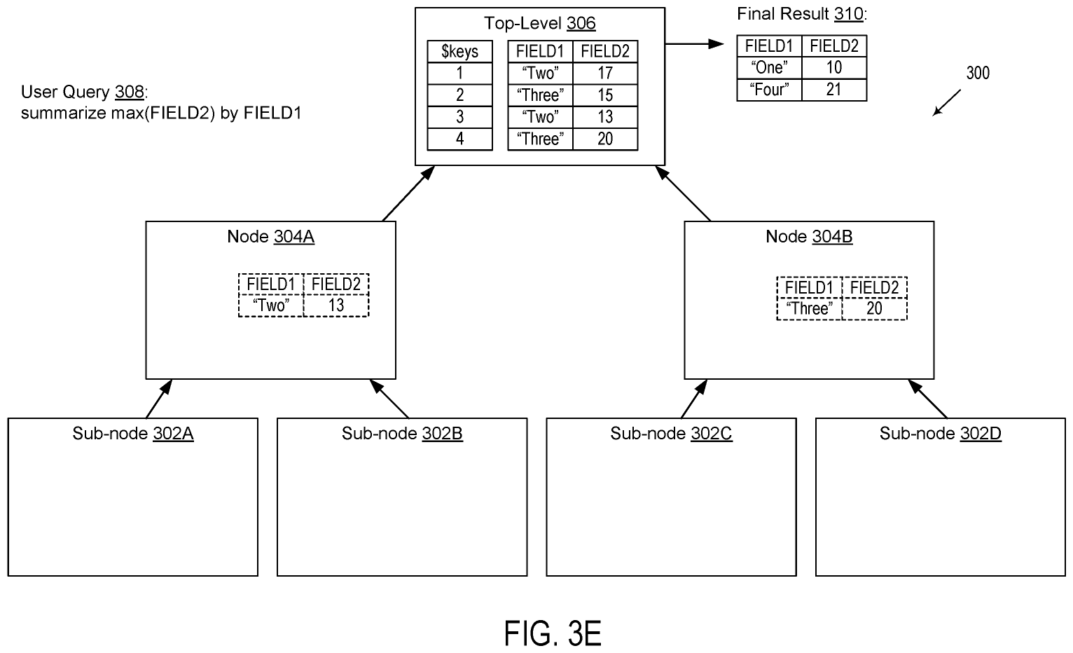

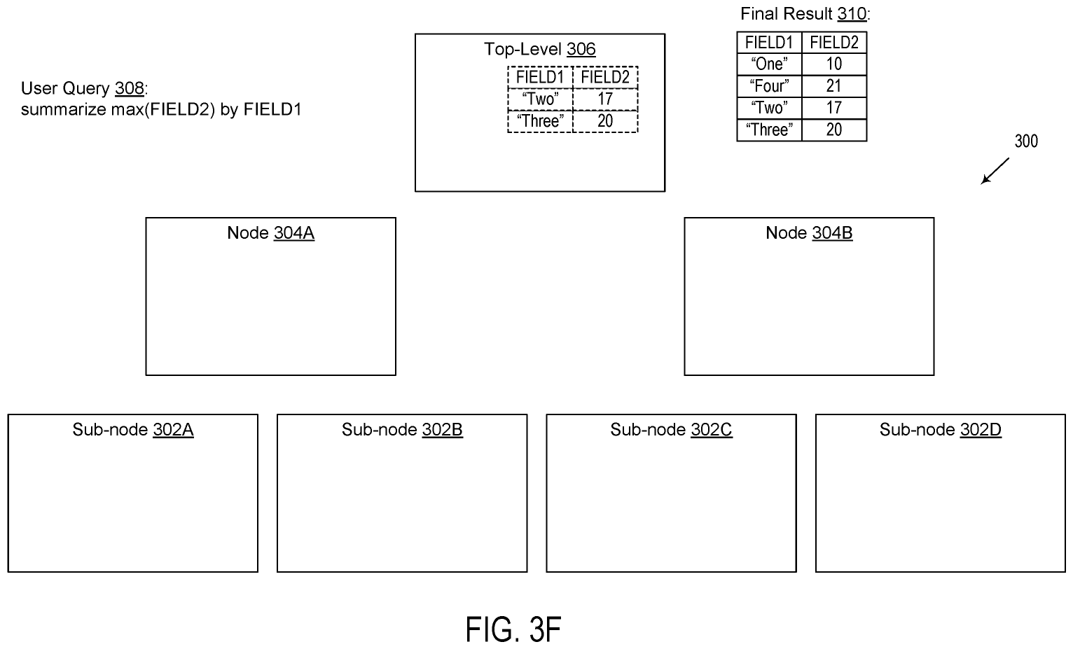

FIGS. 3A-3F show a series of steps for an example two-phase aggregation flow 300. Referring to FIG. 3A, the distributed database system includes four sub-nodes 302A-302D that hold data sets, with each data entry including fields FIELD1 and FIELD2. Sub-nodes 302A, 302B are lower-level nodes relative to node 304A. Sub-nodes 302C, 302D are lower-level nodes relative to node 304B. Nodes 304A, 304B are lower-level nodes relative to top-level node 306. Although the depicted database system illustrates three hierarchy levels, any number of hierarchy levels can be implemented. Furthermore, physical implementations of such systems can also vary. For example, sub-nodes 302A, 302B can be implemented as extents within node 304A.

Referring to FIG. 3B, a user query 308 is provided. In the depicted example, the user query 308 is a “summarize” operator that aggregates the content of the data using a “max” operator. The data is to be queried to find the maximum value of FIELD2 with FIELD1 as the group-by key. The two-phase aggregation flow 300 can start with aggregation computations for the lowest-level nodes—e.g., sub-nodes 302A-302D in the example of FIGS. 3A-3F. In some implementations, the lowest-level nodes initially hold disjointed sets of data. For example, an extent-level node can be implemented within a higher-node to hold disjointed sets of data.

In the first phase of the two-phase aggregation flow 300, the process includes determining occurrences of the group-by key values in the data sets, which can be used to determine disjointed and intersecting keys for lower-level nodes. The occurrence count can be performed by a higher-level node to determine disjointed and intersecting keys for all nodes under said higher-level node. In the depicted example, key hashes of FIELD1 values are streamed to higher-level nodes to determine occurrences of group-by key values. In FIGS. 3A-3F, dashed lines represent streamed data, which can be released from memory after streaming to the caller to reduce peak memory usage.

Key hashes of group-by key values held by sub-nodes 302A and 302B are streamed to node 304A, and key hashes of group-by key values held by sub-nodes 302C and 302D are streamed to node 304B. Nodes 304A, 304B then stream the key hashes to the top-level node 306. As hashes of the same group-by key value return the same key hash, nodes 304A, 304B are aware of the number of occurrences for each FIELD1 value for their respective sub-nodes. Similarly, the top-level node 306 is aware of the number of occurrences for each FIELD1 value for lower-level nodes. In the depicted example, key hashes are streamed. In other examples, the group-by key values are streamed and hashes of the group-by key values are performed in the node to which they were streamed.

Referring to FIG. 3C, the second phase of the example two-phase aggregation flow 300 is initialized. For proper partitioning of the data entries, subqueries in the first phase should be completed before transitioning to the second phase. As such, the various subqueries for the determination of the occurrences of group-by key values that are performing in parallel in the first phase can be coordinated to ensure that such queries are finished before the second phase is initialized. In phase two, disjointed data entries—i.e., data entries with unique FIELD1 values—can be streamed. Nodes stream and return partial results of data entries containing disjointed group-by keys relative to its instance. Starting with sub-node 302A and sub-node 302C (which contain disjointed data entries in the depicted example), the data entries are streamed to node 304A and node 304B, respectively. Nodes 304A and 304B then streams data entries with disjointed keys to the top-level node 306. In the depicted example, the data entry having a FIELD1 value of “One” is disjointed in node 304A (since the combination of sub-nodes 302A and 302B contains a single data entry with a FIELD1 value of “One”). In node 304B, the data entry having a FIELD1 value of “Two” is disjointed. As top-level node 306 is the top-level node, part of the final result 310 can be returned. In the depicted example, top-level node 306 returns a partial result with a data entry having a group-by key value of “One,” which occurs once among sub-nodes 302A-302D.

Referring to FIG. 3D, disjointed data entries from sub-node 302B and 302D are streamed to node 304A and 304B, respectively. In node 304A, the data entry having a FIELD1 value of “Three” is disjointed. In node 304B, the data entry having a FIELD1 value of “Four” is disjointed. These data entries are streamed to the top-level node 306. With respect to the top-level node 306, the data entry having a FIELD1 value of “Four” is disjointed and returned as part of the final result 310.

Referring to FIG. 3E, an aggregation operation can be performed on the remaining data entries, which are data entries having intersecting group-by keys, in each node. By releasing the data entries with disjointed keys from memory after they are streamed, computational and memory usage during the aggregation operation of the data entries with intersecting keys are reduced. Furthermore, key hashes can be released from memory after data is retrieved from all lower-level nodes. In the depicted example, a “max” aggregation operation is performed for each node (304A and 304B), with the results being returned as partial results to the caller, top-level node 306.

Referring to FIG. 3F, an aggregation operation is performed in top-level node 306. The aggregated results are returned and forms the final result 310 when combined with the previously returned partial results.

The two-phase aggregation flow depicted in FIGS. 3A-3F includes partitioning different data sets in parallel and returning partial results to a higher-level node that merges the results. This relies on a correct factorization of the data sets to arrive at the correct aggregation result. To show this, let H be an aggregation function. Let X be the space of all data points. Define P: X→K as the “key map,” that is, maps some data point x∈X to its aggregation key P(x)∈K. Additionally, given some K⊆K, define the Key Subspace X_{K}:={x∈X|P(x)∈K}. Every aggregation function is Key-subspace Invariant, that is, every key-subspace of X is an H-invariant subspace.

For any two key-subspaces A, B⊂X, H(A⊕B)=H(A\B)⊕H(B\A)⊕H(A∩B). To show this, let W=A\B. Observe that W is also a key-subspace, and is thus H-invariant. Therefore, given the orthogonal decomposition, A⊕B=W⊕W′, H is diagonal with respect to the decomposition. That is, H(W⊕W′)=H(W)⊕H(W′). Additionally, letting V=W′\ (A∩B), for V′ such that W′=V⊕V′, H(W′)=H(V)⊕H (V′). Putting this all together results in

$$\begin{matrix}H ( A ⊕ B ) = H ( W ⊕ {W}^{′} ) \\ = H ( W ) ⊕ H ( {W}^{′} ) \\ = H ( W ) ⊕ H ( V ) ⊕ H ( {V}^{′} ) \\ = H ( W ) ⊕ H ( {W}^{′} \text{\textbackslash (} A ⋂ B ) ) ⊕ H ( A ⋂ B ) \\ = H ( A \backslash B ) ⊕ H ( ( ( A ⋃ B ) \text{\textbackslash (} A \backslash B ) ) \text{\textbackslash (} A ⋂ B ) ) ⊕ H ( A ⋂ B ) \\ = H ( A \backslash B ) ⊕ H ( B \backslash A ) ⊕ H ( A ⋂ B ) .\end{matrix}$$

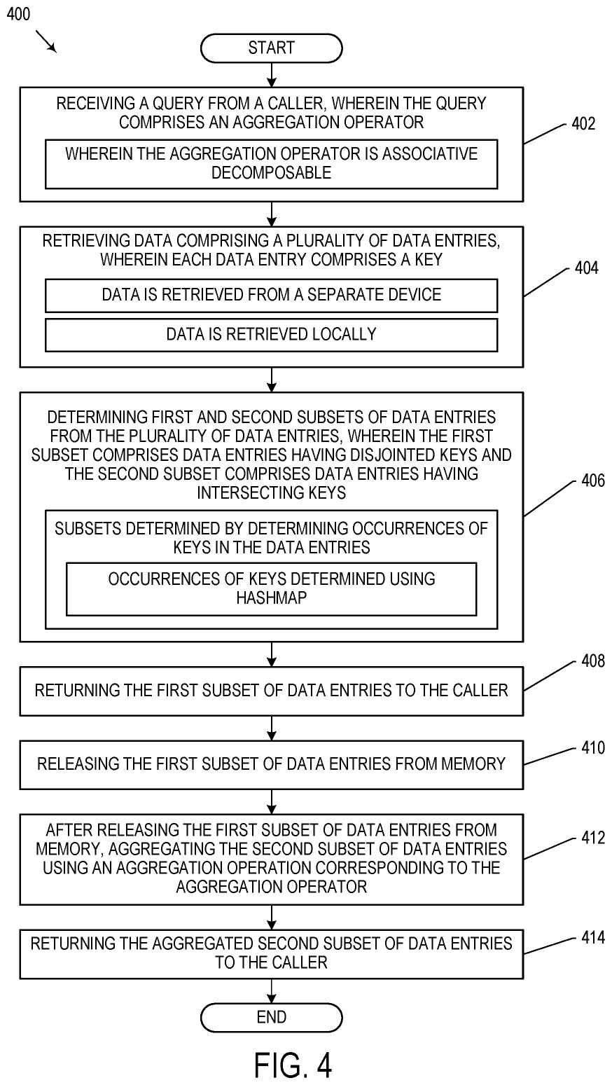

FIG. 4 shows a flow diagram of an example method 400 for streaming aggregation queries. At step 402, the method 400 includes receiving a query from a caller, where the query includes an aggregation operator. The aggregation operator can be associative decomposable, enabling parallel sub-queries in a distributed database system. Example aggregation operators include max, min, make_list, percentile, average, count, and sum.

At step 404, the method 400 includes retrieving data. The data includes a plurality of data entries, and each data entry can include a plurality of fields. For a given query, one of the fields is denoted as a key, or group-by key. The data entries can be formatted in various ways. In some implementations, the data entries are represented as tables of rows and columns. In further examples, each row in a table represents a data entry, with the columns representing the fields of the data entry. The data can be retrieved from various sources, which can depend on the implementation and/or device on which the method 400 is being performed. For example, the distributed database system can be implemented with a plurality of nodes arranged in a tree structure. If the device on which the method 400 is being performed is a node at the lowest level in a distributed database system, the data can be retrieved from local storage of the device. If the device is at a higher-level node, data can be retrieved from lower-level nodes or devices. In some implementations, lower-level nodes are implemented logically within the device. In such cases, data can be retrieved from local storage.

At step 406, the method 400 includes determining first and second subsets of data entries from the plurality of data entries, wherein the first subset includes data entries having disjointed keys and the second subset includes data entries having intersecting keys. The subsets can be determined using various techniques. For example, the second subset of data entries having intersecting keys can be determined by finding data entries having group-by key values that occur more than once in the plurality of data entries. An example technique includes the use of nested loops where each group-by key is compared every other group-by key to determine multiple occurrences. Another technique includes the use of a sorting algorithm to sort the group-by keys. Intersecting group-by keys can be determined by scanning the sorted list to find repeating adjacent elements. In some implementations, a technique with a linear time complexity O(n) is implemented to determine intersecting group-by keys. In further implementations, a hashmap function is utilized to determine intersecting group-by keys.

At step 408, the method 400 includes returning the first subset of data entries to the caller. The caller can depend on the specific implementation. For example, if the device on which method 400 is being performed is a lower-level node, the caller can be a higher-level node. The first subset of data entries can be streamed as partial results to the higher-level node. If the device is a top-level node, the first subset of data entries can be streamed as part of the final result to the user, or caller.

At step 410, the method 400 includes releasing the first subset of data entries from memory. After the first subset of data entries is returned to the caller, it can be released from memory of the device on which method 400 is being performed. By releasing the first subset of data entries from memory, the size of these entries is not accumulated for future steps in the method 400. This can reduce peak memory usage. In previous methods, aggregation operations are performed on the entire data set stored in lower-level nodes. As such, peak memory usage corresponds to the size of the entire data set. By releasing the first subset of data entries from memory, method 400 enables performing aggregation on a portion of the entire data set stored in lower-level nodes, resulting in an aggregation with correct results and lower peak memory usage.

At step 412, the method 400 includes aggregating the second subset of data entries. The second subset of data entries can be aggregated after the first subset of data entries is released from memory. The second subset is aggregated using an aggregation operation that correspond to the aggregation query. Example aggregation operators include max, min, make_list, percentile, average, count, and sum.

At step 414, the method 400 includes returning the aggregated second subset of data entries to the caller. The aggregated second subset of data entries and the previously returned first subset of data entries form the final result to the caller.

In some embodiments, the methods and processes described herein may be tied to a computing system of one or more computing devices. In particular, such methods and processes may be implemented as a computer-application program or service, an application-programming interface (API), a library, and/or other computer-program product.

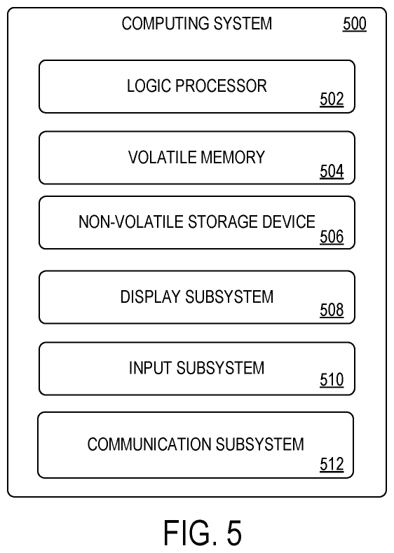

FIG. 5 schematically shows a non-limiting embodiment of a computing system 500 that can enact one or more of the methods and processes described above. Computing system 500 is shown in simplified form. Computing system 500 may embody the computer device 102 described above and illustrated in FIG. 1. Computing system 500 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 500 includes a logic processor 502 volatile memory 504, and a non-volatile storage device 506. Computing system 500 may optionally include a display subsystem 508, input subsystem 510, communication subsystem 512, and/or other components not shown in FIG. 5.

Logic processor 502 includes one or more physical devices configured to execute instructions. For example, the logic processor 502 may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 502 may include one or more physical processors (hardware) configured to execute software instructions. Additionally or alternatively, the logic processor 502 may include one or more hardware logic circuits or firmware devices configured to execute hardware-implemented logic or firmware instructions. Processors of the logic processor 502 may be single-core or multi-core, and the instructions executed thereon may be configured for sequential, parallel, and/or distributed processing. Individual components of the logic processor 502 optionally may be distributed among two or more separate devices, which may be remotely located and/or configured for coordinated processing. Aspects of the logic processor 502 may be virtualized and executed by remotely accessible, networked computing devices configured in a cloud-computing configuration. In such a case, these virtualized aspects are run on different physical logic processors of various different machines, it will be understood.

Non-volatile storage device 506 includes one or more physical devices configured to hold instructions executable by the logic processors to implement the methods and processes described herein. When such methods and processes are implemented, the state of non-volatile storage device 506 may be transformed—e.g., to hold different data.

Non-volatile storage device 506 may include physical devices that are removable and/or built in. Non-volatile storage device 506 may include optical memory (e.g., CD, DVD, HD-DVD, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by logic processor 502 to temporarily store information during processing of software instructions. It will be appreciated that volatile memory 504 typically does not continue to store instructions when power is cut to the volatile memory 504.

Aspects of logic processor 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via logic processor 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices. Such display devices may be combined with logic processor 502, volatile memory 504, and/or non-volatile storage device 506 in a shared enclosure, or such display devices may be peripheral display devices.

When included, input subsystem 510 may comprise or interface with one or more user-input devices such as a keyboard, mouse, trackpad, touch sensitive display, camera, or microphone.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wireless cellular network, or a wired or wireless local- or wide-area network. In some embodiments, the communication subsystem may allow computing system 500 to send and/or receive messages to and/or from other devices via a network such as the Internet.

The following paragraphs provide additional description of aspects of the present disclosure. According to one aspect, a computing device for streaming aggregation queries is provided. The computing device comprises a processor and a memory storing instructions that, when executed by the processor, cause the processor to receive a query from a caller, wherein the query comprises an aggregation operator, retrieve data comprising a plurality of data entries, wherein each data entry comprises a key, determine first and second subsets of data entries from the plurality of data entries, wherein the first subset of data entries comprises data entries having disjointed keys and the second subset of data entries comprises data entries having intersecting keys, return the first subset of data entries to the caller, release the first subset of data entries from the memory, after releasing the first subset of data entries from the memory, aggregate the second subset of data entries using an aggregation operation corresponding to the aggregation operator, and return the aggregated second subset of data entries to the caller. In this aspect, additionally or alternatively, the aggregation operator is associative decomposable. In this aspect, additionally or alternatively, the data resides in a distributed database system comprising a plurality of nodes arranged in a tree structure, and wherein one of the plurality of nodes comprises the computing device. In this aspect, additionally or alternatively, the caller comprises a node higher than the computing device. In this aspect, additionally or alternatively, the data is retrieved from a node lower than the computing device. In this aspect, additionally or alternatively, the node lower than the computing device is a logical node residing in the computing device. In this aspect, additionally or alternatively, the first and second subset of data entries are determined using an algorithm having a linear time complexity. In this aspect, additionally or alternatively, the first and second subset of data entries are determined by determining occurrences of keys. In this aspect, additionally or alternatively, determining occurrences of keys is performed using a hashmap function. In this aspect, additionally or alternatively, the data resides in a distributed database system comprising a plurality of nodes arranged in a tree structure, and wherein determining occurrences of keys is performed by receiving key hashes from at least two nodes in the plurality of nodes.

Another aspect provides a method for streaming aggregation queries. The method comprises receiving a query from a caller, wherein the query comprises an aggregation operator, retrieving data comprising a plurality of data entries, wherein each data entry comprises a key, determining first and second subsets of data entries from the plurality of data entries, wherein the first subset of data entries comprises data entries having disjointed keys and the second subset of data entries comprises data entries having intersecting keys, returning the first subset of data entries to the caller, releasing the first subset of data entries from memory, after releasing the first subset of data entries from memory, aggregating the second subset of data entries using an aggregation operation corresponding to the aggregation operator, and returning the aggregated second subset of data entries to the caller. In this aspect, additionally or alternatively, aggregating the second subset of data entries is performed after returning the first subset of data entries to the caller. In this aspect, additionally or alternatively, the data resides in a distributed database system comprising a plurality of nodes arranged in a tree structure. In this aspect, additionally or alternatively, the first and second subset of data entries are determined using an algorithm having a linear time complexity. In this aspect, additionally or alternatively, the first and second subset of data entries are determined by determining occurrences of keys using a hashmap function.

Another aspect provides a computing device for streaming aggregation queries. The computing device comprises a processor and memory storing instructions that, when executed by the processor, cause the processor to receive a query from a caller, wherein the query comprises an aggregation operator, determine occurrences of keys in a plurality of nodes, retrieve a first set of data entries from a first node in the plurality of nodes, return a subset of data entries from the first set of data entries to the caller, wherein the subset of data entries from the first set of data entries is determined based on the determined occurrences of keys, release the subset of data entries from the first set of data entries from the memory, after releasing the subset of data entries from the first set of data entries from the memory, retrieve a second set of data entries from a second node in the plurality of nodes, return a subset of data entries from the second set of data entries to the caller, wherein the subset of data entries from the second set of data entries is determined based on the determined occurrences of keys, release the subset of data entries from the second set of data entries from the memory, after releasing the subset of data entries from the second set of data entries from the memory, aggregate remaining entries in the first set of entries and the second set of entries using an aggregation operation corresponding to the aggregation operator, and return the aggregated remaining entries to the caller. In this aspect, additionally or alternatively, the subset of data entries from the first set of data entries comprises data entries having keys that occur once in the first set of data entries. In this aspect, additionally or alternatively, determining occurrences of keys in the plurality of nodes is performed using an algorithm having a linear time complexity. In this aspect, additionally or alternatively, determining occurrences of keys in the plurality of nodes is performed using a hashmap function. In this aspect, additionally or alternatively, determining occurrences of keys is performed by receiving key hashes from at least two nodes in the plurality of nodes.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device for streaming aggregation queries, the computing device comprising:
a processor; and
a memory storing instructions that, when executed by the processor, cause the processor to:
receive a query from a caller, wherein the query comprises an aggregation operator;
retrieve data comprising a plurality of data entries, wherein each data entry comprises a key;
determine first and second subsets of data entries from the plurality of data entries, wherein the first subset of data entries comprises data entries having disjointed keys and the second subset of data entries comprises data entries having intersecting keys;
return the first subset of data entries to the caller;
release the first subset of data entries from the memory;
after releasing the first subset of data entries from the memory, aggregate the second subset of data entries using an aggregation operation corresponding to the aggregation operator; and
return the aggregated second subset of data entries to the caller.

2. The computing device of claim 1, wherein the aggregation operator is associative decomposable.

3. The computing device of claim 1, wherein the data resides in a distributed database system comprising a plurality of nodes arranged in a tree structure, and wherein one of the plurality of nodes comprises the computing device.

4. The computing device of claim 3, wherein the caller comprises a node higher than the computing device.

5. The computing device of claim 3, wherein the data is retrieved from a node lower than the computing device.

6. The computing device of claim 5, wherein the node lower than the computing device is a logical node residing in the computing device.

7. The computing device of claim 1, wherein the first and second subset of data entries are determined using an algorithm having a linear time complexity.

8. The computing device of claim 1, wherein the first and second subset of data entries are determined by determining occurrences of keys.

9. The computing device of claim 8, wherein determining occurrences of keys is performed using a hashmap function.

10. The computing device of claim 1, wherein the data resides in a distributed database system comprising a plurality of nodes arranged in a tree structure, and wherein determining occurrences of keys is performed by receiving key hashes from at least two nodes in the plurality of nodes.

11. A method for streaming aggregation queries, the method comprising:
receiving a query from a caller, wherein the query comprises an aggregation operator;
retrieving data comprising a plurality of data entries, wherein each data entry comprises a key;
determining first and second subsets of data entries from the plurality of data entries, wherein the first subset of data entries comprises data entries having disjointed keys and the second subset of data entries comprises data entries having intersecting keys;
returning the first subset of data entries to the caller;
releasing the first subset of data entries from memory;
after releasing the first subset of data entries from memory, aggregating the second subset of data entries using an aggregation operation corresponding to the aggregation operator; and
returning the aggregated second subset of data entries to the caller.

12. The method of claim 11, wherein aggregating the second subset of data entries is performed after returning the first subset of data entries to the caller.

13. The method of claim 11, wherein the data resides in a distributed database system comprising a plurality of nodes arranged in a tree structure.

14. The method of claim 11, wherein the first and second subset of data entries are determined using an algorithm having a linear time complexity.

15. The method of claim 11, wherein the first and second subset of data entries are determined by determining occurrences of keys using a hashmap function.

16. A computing device for streaming aggregation queries, the computing device comprising:
a processor; and
a memory storing instructions that, when executed by the processor, cause the processor to:
receive a query from a caller, wherein the query comprises an aggregation operator;
determine occurrences of keys in a plurality of nodes;
retrieve a first set of data entries from a first node in the plurality of nodes;
return a subset of data entries from the first set of data entries to the caller, wherein the subset of data entries from the first set of data entries is determined based on the determined occurrences of keys;
release the subset of data entries from the first set of data entries from the memory;
after releasing the subset of data entries from the first set of data entries from the memory, retrieve a second set of data entries from a second node in the plurality of nodes;
return a subset of data entries from the second set of data entries to the caller, wherein the subset of data entries from the second set of data entries is determined based on the determined occurrences of keys;
release the subset of data entries from the second set of data entries from the memory;
after releasing the subset of data entries from the second set of data entries from the memory, aggregate remaining data entries in the first set of data entries and the second set of data entries using an aggregation operation corresponding to the aggregation operator; and
return the aggregated remaining entries to the caller.

17. The computing device of claim 16, wherein the subset of data entries from the first set of data entries comprises data entries having keys that occur once in the first set of data entries.

18. The computing device of claim 16, wherein determining occurrences of keys in the plurality of nodes is performed using an algorithm having a linear time complexity.

19. The computing device of claim 16, wherein determining occurrences of keys in the plurality of nodes is performed using a hashmap function.

20. The computing device of claim 16, wherein determining occurrences of keys is performed by receiving key hashes from at least two nodes in the plurality of nodes.
